(19) United States
(12) Patent Application Publication
(10) Pub. No.: US 2024/0039427 A1
(43) Pub. Date: Feb. 1, 2024

(54) POWER CONVERTING APPARATUS, MOTOR DRIVE APPARATUS, AND REFRIGERATION CYCLE APPLICATION DEVICE

(71) Applicant: Mitsubishi Electric Corporation, Tokyo (JP)

(72) Inventors: Koichi ARISAWA, Tokyo (JP); Takaaki TAKAHARA, Tokyo (JP); Haruka MATSUO, Tokyo (JP); Keisuke UEMURA, Tokyo (JP)

(21) Appl. No.: 18/256,666

(22) PCT Filed: Feb. 12, 2021
(86) PCT No.: PCT/JP2021/005357

§ 371 Date: Jun. 9, 2023

(51) Int. Cl. H02M 7/5387; H02P 27/06; H02M 1/14; H02P 21/30

(52) U.S. Cl. CPC H02M 7/53873; H02P 27/06; H02M 1/143; H02P 21/30

(57) ABSTRACT

A power converting apparatus includes a converter, a smoothing unit, inverters, and a control unit. The inverters are connected to the converter, the inverters being in parallel connection with each other. The inverter converts power output from the smoothing unit into a first alternating-current power, and outputs the first alternating-current power to a device in which a motor is installed. The inverter converts power outputted from the smoothing unit into a second alternating-current power, and outputs the second alternating-current power to a device in which a motor is installed. The control unit controls an operation of the converter and the inverters to reduce a current flowing in the smoothing unit and concurrently controls an operation of the inverter in accordance with an operation state of the inverter and a load unit including the device.

### CROSS REFERENCE TO RELATED APPLICATION

This application is a U.S. national stage application of PCT/JP2021/005357 filed on Feb. 12, 2021, the contents of which are incorporated herein by reference.

### TECHNICAL FIELD

The present disclosure relates to a power converting apparatus that converts alternating-current power into desired power, a motor drive apparatus, and a refrigeration cycle application device.

### BACKGROUND

Conventionally, there has been a power converting apparatus that converts alternating-current power supplied from an alternating-current power supply into desired alternating-current power and supplies the alternating-current power to a load such as an air conditioner. For example, Patent Literature 1 described below discloses a technique in which a power converting apparatus that is a control apparatus of an air conditioner rectifies alternating-current power supplied from an alternating-current power supply with a diode stack that is a converter, further converts power smoothed by a smoothing unit into desired alternating-current power with an inverter composed of a plurality of switching elements, and outputs the desired alternating-current power to a compressor motor that is a load.

### PATENT LITERATURE

Patent Literature 1: Japanese Patent Application Laid-open No. 7-71805

However, in the technique of Patent Literature 1 listed above, since a large electric current flows in the smoothing unit, there is a problem that aged deterioration of the smoothing unit is accelerated and a life-span of the capacitor is shortened. With respect to such a problem, the conventional art including Patent Literature 1 has no idea of extending the life-span of the capacitor by using an apparatus configuration in which two or more devices are driven by one converter and a plurality of inverters connected to the one converter as in an air conditioner.

### SUMMARY

The present disclosure has been made in view of the above circumstances, and an object thereof is to provide a power converting apparatus capable of extending the life-span of a smoothing unit by using an apparatus configuration in which two or more devices are driven by one converter and a plurality of inverters connected to the converter.

In order to solve the above-described problems and achieve the object, the present disclosure a power converting apparatus comprising: a converter rectifying a power supply voltage applied from an alternating-current power supply and, if necessary, boosting the power supply voltage; a smoothing unit connected to an output end of the converter; a first inverter connected to the output end of the converter, the first inverter converting power outputted from the converter and the smoothing unit into a first alternating-current power and outputting the first alternating-current power to a first device in which a first motor is installed; a second inverter connected in parallel with the first inverter, the second inverter converting power outputted from the converter and the smoothing unit into a second alternating-current power and outputting the second alternating-current power to a second device in which a second motor is installed; and a control unit controlling an operation of the converter, the first inverter, or the second inverter to reduce an electric current flowing in the smoothing unit, and concurrently controlling an operation of the first inverter in accordance with an operation state of the second inverter and a second load unit, the second load unit including the second device.

The power converting apparatus according to the present disclosure provides an advantageous effect that it can extend the life-span of a smoothing unit by using an apparatus configuration in which two or more devices are driven by one converter and a plurality of inverters connected to the converter.

### BRIEF DESCRIPTION OF DRAWINGS

FIG. 1 is a diagram used to describe a basic configuration and a basic function of a power converting apparatus according to a first embodiment.

FIG. 2 is a diagram illustrating another configuration example having a basic function of the power converting apparatus illustrated in FIG. 1.

FIG. 3 is a diagram illustrating still another configuration example having a basic function of the power converting apparatus illustrated in FIG. 1.

FIG. 4 is a diagram illustrating an operation mode and a brief summary of the operation mode of the first embodiment.

FIG. 5 is a chart used to describe power supply pulsation compensation control of the first embodiment.

FIG. 6 is a chart illustrating an operation waveform of each unit compared with FIG. 5 as a comparative example.

FIG. 7 is a diagram illustrating a configuration example of the power converting apparatus according to the first embodiment.

FIG. 8 is a diagram illustrating a first configuration example embodying the power converting apparatus according to the first embodiment.

FIG. 9 is a chart used to describe a pulsation current correction method of the first embodiment.

FIG. 10 is a diagram illustrating a second configuration example embodying the power converting apparatus according to the first embodiment.

FIG. 11 is a diagram illustrating a third configuration example embodying the power converting apparatus according to the first embodiment.

FIG. 12 is a diagram illustrating a fourth configuration example embodying the power converting apparatus according to the first embodiment.

FIG. 13 is a diagram illustrating a fifth configuration example embodying the power converting apparatus according to the first embodiment.

FIG. 14 is a block diagram illustrating an example of a hardware configuration that implements a function for a control unit according to the first embodiment.

FIG. 15 is a block diagram illustrating another example of a hardware configuration that implements the function for the control unit according to the first embodiment.

FIG. 16 is a diagram illustrating a configuration example of a refrigeration cycle application device according to a second embodiment.

### DETAILED DESCRIPTION

Hereinafter, a power converting apparatus, a motor drive apparatus, and a refrigeration cycle application device according to embodiments of the present disclosure will be described in detail with reference to the accompanying drawings.

### First Embodiment

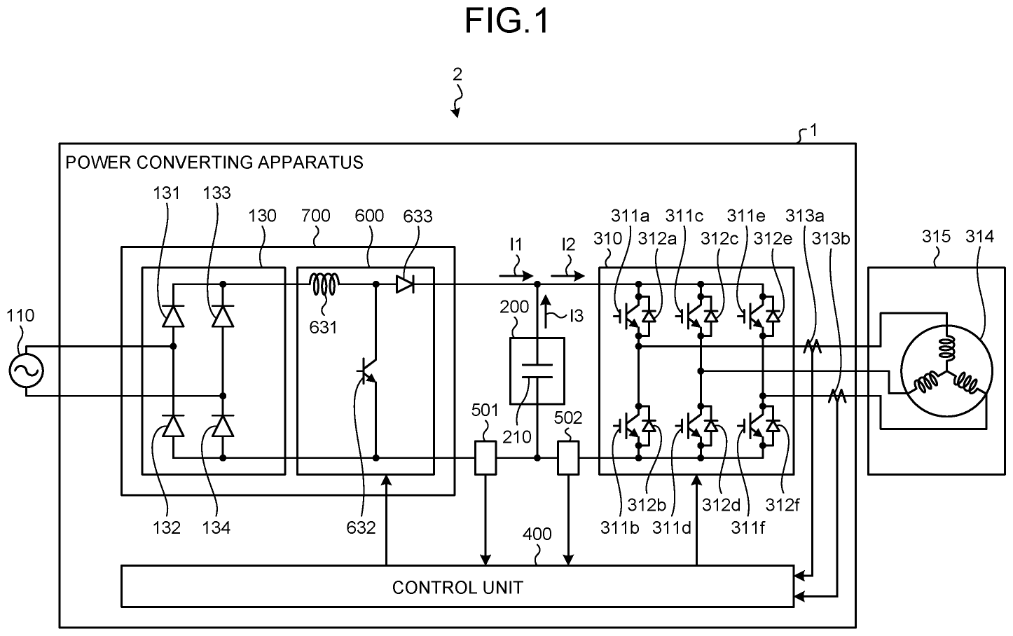

FIG. 1 is a diagram used to describe a basic configuration and a basic function of the power converting apparatus according to the first embodiment. In FIG. 1, a power converting apparatus 1 is connected to a commercial power supply 110 and a compressor 315. The commercial power supply 110 is an example of an alternating-current power supply, and the compressor 315 is an example of a device referred to in the first embodiment. A motor 314 is installed in the compressor 315. The power converting apparatus 1 and the motor 314 included in the compressor 315 constitute a motor drive apparatus 2.

The power converting apparatus 1 includes a rectification unit 130, a boosting unit 600, a current detection unit 501, a smoothing unit 200, a current detection unit 502, an inverter 310, current detection units 313a and 313b, and a control unit 400. Note that, in the power converting apparatus 1, the rectification unit 130 and the boosting unit 600 constitute a converter 700.

The rectification unit 130 includes a bridge circuit composed of rectifying elements 131 to 134. The rectification unit 130 rectifies the power supply voltage applied from the commercial power supply 110, and outputs the rectified power supply voltage to the boosting unit 600. The rectification unit 130 having the configuration of FIG. 1 performs full-wave rectification.

The boosting unit 600 includes a reactor 631, a switching element 632, and a diode 633. In the boosting unit 600, the switching element 632 is controlled to be turned on or off by a control signal outputted from the control unit 400. When the switching element 632 is controlled to be turned on, the rectified voltage is short-circuited via the reactor 631. This operation is called “power supply short-circuit operation”. When the switching element 632 is controlled to be turned off, the rectified voltage is applied to the smoothing unit 200 via the reactor 631. This operation is a normal rectification operation. At this time, in a state where energy has been accumulated in the reactor 631, the output voltage of the rectification unit 130 and the voltage generated in the reactor 631 are added and applied to the smoothing unit 200.

The boosting unit 600 boosts the rectified voltage by alternately repeating the power supply short-circuit operation and the rectification operation. This operation is called “boosting operation”. By the boosting operation, the voltage between both ends of the smoothing unit 200 is boosted to a voltage higher than the power supply voltage. In addition, the boosting operation improves a power factor in an electric current flowing between the commercial power supply 110 and the converter 700. On the other hand, when the switching element 632 is always off, the voltage outputted from the rectification unit 130 is outputted without being boosted.

As described above, the converter 700 rectifies the power supply voltage applied from the commercial power supply 110 and, if necessary, performs the operation of boosting the power supply voltage.

The smoothing unit 200 includes a capacitor 210. The smoothing unit 200 is connected to an output end of the converter 700. The capacitor 210 smooths the rectified voltage outputted by the converter 700. Examples of the capacitor 210 include an electrolytic capacitor and a film capacitor.

The voltage generated in the capacitor 210 does not have a full-wave rectified waveform shape of the commercial power supply 110, but has a waveform shape in which a voltage ripple according to the frequency of the commercial power supply 110 is superimposed on a direct-current component, with the latter waveform shape having no great pulsation. In the case where the commercial power supply 110 is a single-phase power supply, frequencies of this voltage ripple has a main component that is a component of twice the frequency of the power supply voltage, but in the case where the commercial power supply 110 is a three-phase power supply, the frequencies of the voltage ripple has a main component that is a component of six times the frequency of the power supply voltage. When an electric power inputted from the commercial power supply 110 and an electric power outputted from the inverter 310 do not change, the amplitude of the voltage ripple is determined by an electrostatic capacitance of the capacitor 210. However, in the power converting apparatus according to the present disclosure, an increase in electrostatic capacitance is avoided in order to reduce an increase in cost of the capacitor 210. In association with this situation, a certain degree of voltage ripple occurs in the capacitor 210. For example, the voltage of the capacitor 210 is a voltage that pulsates in such a range that the maximum value of the voltage ripple is less than twice the minimum value thereof.

The current detection unit 501 detects a converter current I1 that is an electric current flowing in and out of the converter 700, and outputs a detected current value to the control unit 400. In addition, the current detection unit 502 detects an inverter current I2 that is an electric current flowing in and out of the inverter 310, and outputs a detected current value to the control unit 400.

The inverter 310 is connected to an output end of the converter 700. The inverter 310 includes switching elements 311a to 311f and freewheeling diodes 312a to 312f. The inverter 310 turns on and off the switching elements 311a to 311f under the control of the control unit 400 to convert the power outputted from the converter 700 and the smoothing unit 200 into an alternating-current power having desired amplitude and phase, and outputs the alternating-current power to the compressor 315 that is a device in which the motor 314 is installed.

The current detection units 313a and 313b each detect an electric current for one phase out of electric currents for three phases outputted from the inverter 310. Each detection value of the current detection units 313a and 313b is inputted to the control unit 400. On the basis of the detection values of the currents for any two phases detected by the current detection units 313a and 313b, the control unit 400 computationally obtains an electric current for the remaining one phase.

The control unit 400 uses the detection values of the electric currents detected by the current detection units 501 and 502 and the current detection units 313a and 313b to control the operation of the boosting unit 600 in the converter 700, specifically, on/off operation of the switching element 632 included in the boosting unit 600. In addition, the control unit 400 controls the operation of the inverter 310, specifically, on/off operation of the switching elements 311a to 311f included in the inverter 310, with use of the detection values detected by the detection units.

The motor 314 installed in the compressor 315 rotates according to the amplitude and phase of the alternating-current power supplied from the inverter 310, so as to perform a compression operation. In the case where the compressor 315 is a hermetic type compressor used in an air conditioner or the like, a load torque of the compressor 315 can be regarded as a constant torque load in many cases.

Note that FIG. 1 illustrates a case where the motor winding of the motor 314 is of Y-connection, but the present disclosure is not limited to this example. The motor winding of the motor 314 may be of A-connection, or may be configured according to specifications by which switching between Y-connection and A-connection can be realized.

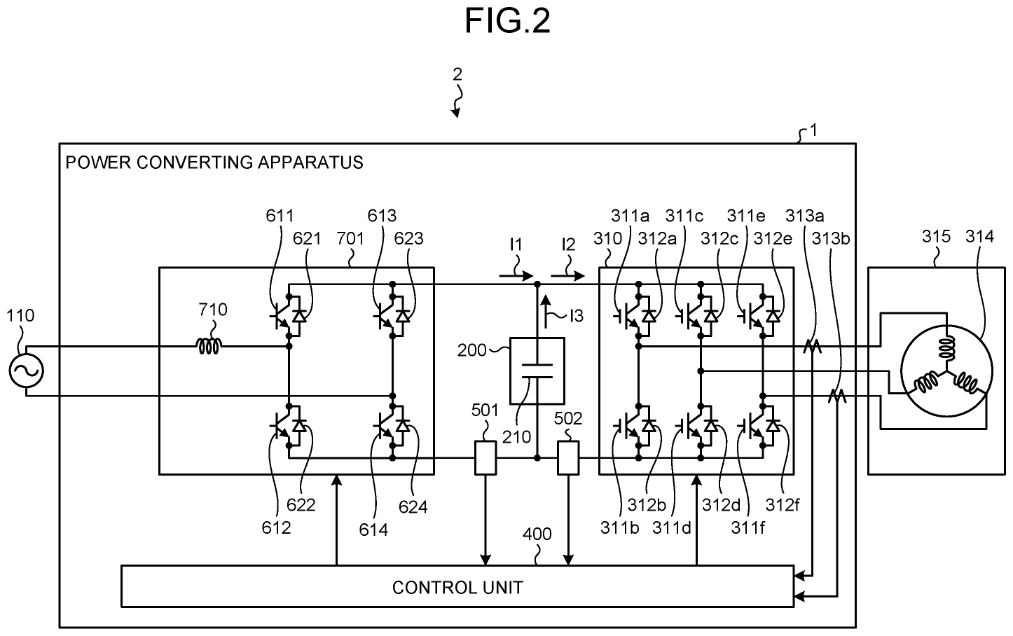

In addition, in the power converting apparatus 1, organization and geometry of the units illustrated in the basic configuration of FIG. 1 are an example, and the organization and geometry of the units are not limited to the example illustrated in FIG. 1. For example, the configuration may be as illustrated in FIG. 2. FIG. 2 is a diagram illustrating another configuration example having a basic function of the power converting apparatus illustrated in FIG. 1.

In FIG. 2, the converter 700 illustrated in FIG. 1 is replaced with a converter 701. Similarly to the converter 700 illustrated in FIG. 1, the converter 701 is a component having both a rectification function and a boosting function.

The converter 701 includes a reactor 710, switching elements 611 to 614, and rectifying elements 621 to 624 that are connected in parallel with the switching elements 611 to 614, respectively. Other configurations are the same as or equivalent to those of the power converting apparatus 1 illustrated in FIG. 1, and the same or equivalent components are denoted by the same reference symbols. In addition, although the reactor 710 of this configuration is inserted only in a one-side connection line between the commercial power supply 110 and the converter 701, reactors may be inserted in both-side connection lines, respectively.

In the converter 701, the switching elements 611 to 614 are controlled to be turned on or off by a control signal outputted from the control unit 400. The converter 701 alternately repeats the power supply short-circuit operation and the rectification operation. By so doing, the converter 701 rectifies the power supply voltage applied from the commercial power supply 110 and, if necessary, boosts the rectified voltage. By the boosting operation, the voltage between both ends of the smoothing unit 200 is boosted to a voltage higher than the power supply voltage. In addition, the boosting operation improves the power factor in an electric current flowing between the commercial power supply 110 and the converter 701.

As described above, the power converting apparatus 1 illustrated in FIG. 2 has the same basic functions as those of the power converting apparatus 1 illustrated in FIG. 1. Therefore, it can be applied to a power converting apparatus 1A described later.

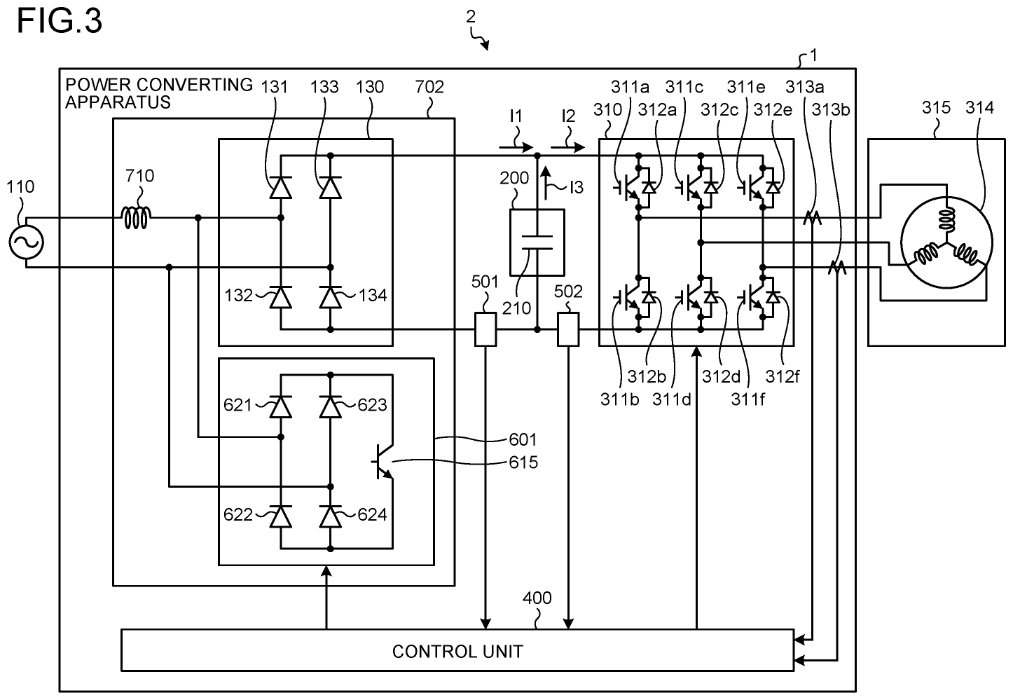

In addition, for example, the configuration may be modified as illustrated in FIG. 3. FIG. 3 is a diagram illustrating still another configuration example having a basic function of the power converting apparatus illustrated in FIG. 1.

In FIG. 3, the converter 700 illustrated in FIG. 1 is replaced with a converter 702. In the converter 702, the boosting unit 600 is replaced with a boosting unit 601 and the reactor 710. The reactor 710 is disposed between the commercial power supply 110 and the rectification unit 130. Similarly to the converter 700 illustrated in FIG. 1, the converter 702 is a component having both a rectification function and a boosting function.

The boosting unit 601 includes the rectifying elements 621 to 624 and a switching element 615. The boosting unit 601 is connected in parallel with the rectification unit 130. Other configurations are the same as or equivalent to those of the power converting apparatus 1 illustrated in FIG. 1, and the same or equivalent components are denoted by the same reference symbols.

In the converter 702, the switching element 615 is controlled to be turned on or off by a control signal outputted from the control unit 400. The boosting unit 601 performs the power supply short-circuit operation. The rectification unit 130 performs the rectification operation. The converter 702 alternately repeats the power supply short-circuit operation and the rectification operation. In this way, the converter 702 rectifies the power supply voltage applied from the commercial power supply 110 and, if necessary, boosts the rectified voltage. By the boosting operation, the voltage between both ends of the smoothing unit 200 is boosted to a voltage higher than the power supply voltage. In addition, the boosting operation improves the power factor in an electric current flowing between the commercial power supply 110 and the converter 702.

As described above, the power converting apparatus 1 illustrated in FIG. 3 has the same basic functions as those of the power converting apparatus 1 illustrated in FIG. 1. Therefore, it can be applied to a power converting apparatus 1A described later.

Note that, in the following, unless otherwise specified, the power converting apparatus 1 illustrated in FIG. 1 will be described as an example. In addition, in the following description, the current detection units 501, 502, 313a, and 313b may be sometimes collectively referred to as a detection unit. In addition, the current values detected by the current detection units 501, 502, 313a, and 313b may be sometimes referred to as detection values. The power converting apparatus 1 may include some detection unit other than the above-described detection units. Although not illustrated in FIG. 1, the power converting apparatus 1 generally includes a detection unit that detects a capacitor voltage. The power converting apparatus 1 may include a detection unit that detects a voltage, a current, or the like of an alternating-current power supplied from the commercial power supply 110.

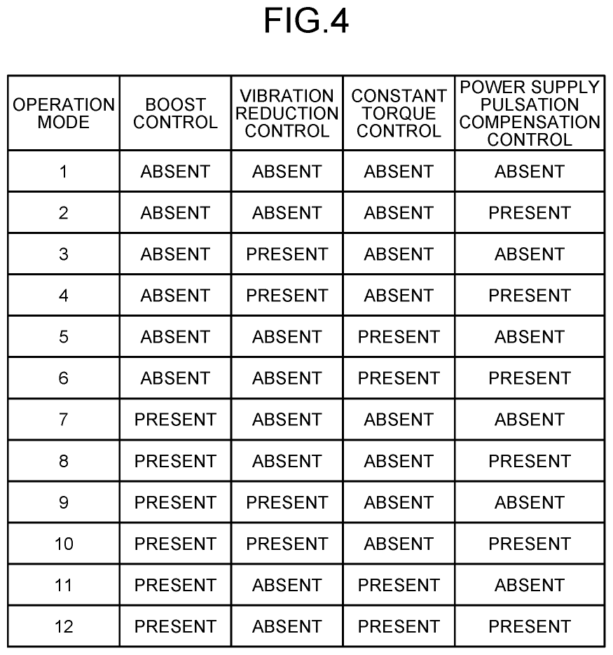

Next, an operation mode of the first embodiment will be described with reference to FIG. 4. FIG. 4 is a diagram illustrating an operation mode and a brief summary of the operation mode in the first embodiment.

The boost control refers to control in which the boosting unit 600 boosts the power supply voltage applied from the commercial power supply 110 in order to secure the drive range of the motor 314 that is in high-speed rotating. Specifically, the control unit 400 controls on/off operation of the switching element 632 of the boosting unit 600.

The vibration reduction control refers to control in which when vibration is caused by torque pulsation resulting from a mechanical mechanism including the compressor 315 and the like during one revolution of the motor 314, the torque applied from the inverter 310 is adjusted to match the torque pulsation to thereby reduce the vibration.

The constant torque control refers to control for reducing load current pulsation by making the torque to be applied from the inverter 310 to the motor 314 constant. The constant torque control is also called constant current control. Even in a system having torque pulsation, the amount of vibration is not so large when the operation is performed in a range of a relatively light load. For this reason, by making the torque to be provided from the inverter 310 constant, the electric current waveform of the motor 314 becomes a sinusoidal waveform, that is, a waveform having no pulsation, thereby enabling high-efficiency operation. Note that the constant torque control can be used when vibration is allowable even in a range of a heavy load.

The power supply pulsation compensation control refers to control for reducing a pulsation component of a smoothing unit current I3 that is an electric current flowing in the smoothing unit 200. A ripple current caused by the power supply pulsation passes through the capacitor 210 of the smoothing unit 200 and the electric power is accordingly transmitted to a load part/unit including the inverter 310 and the compressor 315, so that the stress on the capacitor 210 can be alleviated. Note that the content of details of the power supply pulsation compensation control will be described later.

As illustrated in FIG. 4, the power converting apparatus 1 according to the first embodiment has twelve operation modes. These operation modes 1 to 12 are determined by each combination of the presence or absence of the boost control, the presence or absence of the vibration reduction control, the presence or absence of the constant torque control, and the presence or absence of the power supply pulsation compensation control. The presence or absence of each control illustrated in FIG. 4 is determined by the control unit 400 according to the operation state of the load part/unit including the inverter 310 and the compressor 315. That is, the control unit 400 determines the presence or absence of each control according to the operation state of the load part/unit, and maintains or switches the operation mode.

Note that, in the example of FIG. 4, four items are mentioned as specific contents of the operation mode, but they are an example and the present disclosure is not limited thereto. One or some items of the four items may be an object to be controlled, or an item other than the four items may further be an object to be controlled. Examples of the items other than the four items include flux weakening control and overmodulation control.

The flux weakening control refers to control to expand a high-speed rotation range of the motor 314 by providing a negative d-axis current to the motor 314 to reduce an apparent electromotive force.

The overmodulation control refers to control for applying a voltage larger than the electromotive force of the motor 314 from the inverter 310 to the motor 314 in order to drive the motor 314. In the case where the commercial power supply 110 is used, the power converting apparatus 1 is subjected to limitation in a supply voltage thereof. For this reason, when the motor 314 rotates at a high speed, the electromotive force of the motor 314 becomes larger than the supply voltage, thereby making it difficult to continue the rotation. Thence, the power converting apparatus 1 slightly raises a fundamental wave component of the output voltage by distorting the output voltage from the inverter 310, specifically, by incorporating a third-order harmonic component in the output voltage. By doing so, the power converting apparatus 1 can increase the high-speed rotation range of the motor 314.

Note that although power factor improvement control of the alternating-current power supplied from the commercial power supply 110 and average voltage control of the capacitor 210 of the smoothing unit 200 are not mentioned in FIG. 4, these controls are performed regardless of the operation mode.

Regarding the operation state, the power converting apparatus 1 can detect the converter current I1 by an electric current value, for example, a detection value of the current detection unit 501, and can detect the inverter current I2 by a detection value of the current detection unit 502.

In addition, regarding the operation state, the power converting apparatus 1 can detect the temperature, for example, in the case of being installed in an air conditioner, the temperature according to a detection value of a temperature sensor of the indoor unit provided in the air conditioner, a detection value of a temperature sensor of the outdoor unit, or the like. Note that the power converting apparatus 1 may be configured to include a temperature sensor around a substrate of the inverter 310 to detect the temperature around the substrate of the inverter 310, or to include a temperature sensor around the motor 314 to detect the temperature around the motor 314.

In addition, regarding the operation state, the power converting apparatus 1 can directly or indirectly detect an operation speed, for example, an operation speed of the motor 314 of the compressor 315, a fan (not illustrated) installed in the air conditioner, or the like on the basis of a command value generated in the course of control of the control unit 400, an estimation value estimated from an operation frequency in the course of control of the control unit 400, or the like.

As described above, the operation state of the power converting apparatus 1 is obtained by at least one of the detection value of the detection unit that detects a physical quantity using the inverter 310, the motor 314, or the compressor 315 as an object to be detected, the command value generated in the course of control of the control unit 400, and the estimation value estimated in the course of control of the control unit 400. The physical quantity may be, for example, a voltage value or the like, not only the current value, temperature, and operation speed described above.

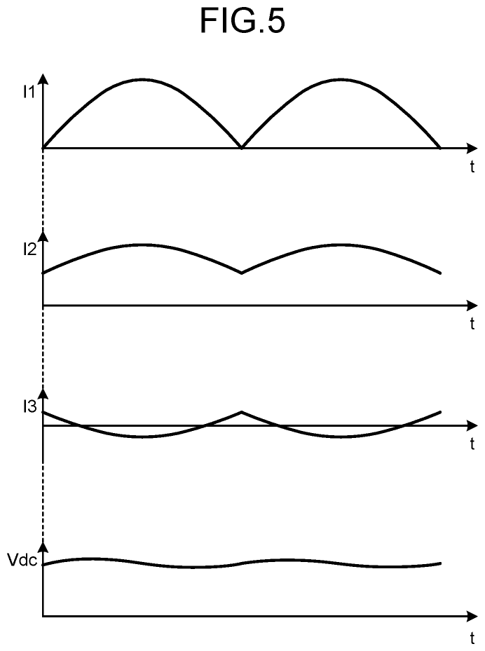

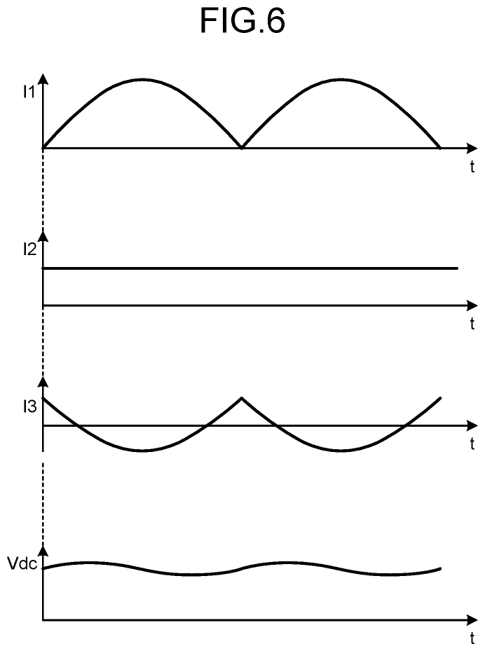

Next, the power supply pulsation compensation control of the first embodiment will be described. Note that in the description of FIGS. 5 and 6, it is assumed that the load generated by the inverter 310 and the compressor 315 can be regarded as a constant load in the power converting apparatus 1. In addition, it is assumed that a constant current load is connected to the smoothing unit 200 in terms of an electric current outputted from the smoothing unit 200.

Here, a direction of the smoothing unit current I3 flowing out from the smoothing unit 200, that is, a discharging direction thereof is defined as positive as indicated by its arrow in FIG. 1. When defined in this way, a relationship “I3=I1−I2” is established among the converter current I1, the inverter current I2, and the smoothing unit current I3. The control unit 400 can computationally obtain the smoothing unit current I3 with use of the detection values of the converter current I1 and the inverter current I2.

FIG. 5 is a diagram used to describe the power supply pulsation compensation control of the first embodiment. FIG. 5 illustrates an operation waveform example of each unit when the control unit 400 of the power converting apparatus 1 according to the first embodiment controls the operation of the inverter 310 to reduce the smoothing unit current I3. Specifically, there are illustrated the converter current I1, the inverter current I2, the smoothing unit current I3, and a capacitor voltage Vdc that is a voltage across the capacitor 210 generated according to the smoothing unit current I3 in order from an upper part of the figure. The horizontal axes all represent time t, the vertical axes for the converter current I1, the inverter current I2, and the smoothing unit current I3 represent a current value, and the vertical axis for the capacitor voltage Vdc represents a voltage value.

In addition, FIG. 6 is a diagram illustrating an operation waveform of each unit compared with FIG. 5 as a comparative example. FIG. 6 illustrates a waveform example of each unit when the inverter current I2 is made constant in smoothing an electric current outputted from the converter 700 in the smoothing unit 200. Specifically, similarly to FIG. 5, there are illustrated the converter current I1, the inverter current I2, the smoothing unit current I3, and the capacitor voltage Vdc in order from an upper part of the figure. Note that scales of the physical quantities represented by the horizontal axis and the vertical axes are the same as those of FIG. 5.

Note that in each figure of FIGS. 5 and 6, a carrier component of the inverter 310 is practically superimposed on the inverter current I2 and the smoothing unit current I3, but this superimposition is omitted here. The same applies to the following description.

Now what is considered is a case where the converter current I1 flowing from the boosting unit 600 is sufficiently smoothed by the smoothing unit 200 in the power converting apparatus 1. In this case, the inverter current I2 has a constant current value as illustrated in FIG. 6. However, in the capacitor 210, a large pulsation component is included in the smoothing unit current I3 as illustrated in FIG. 6, which causes deterioration of the capacitor 210.

Thence, in the power converting apparatus 1 according to the first embodiment, the operation of the inverter 310 is controlled by the control unit 400 so that the pulsation component of the smoothing unit current I3 is reduced. Specifically, the control unit 400 controls the operation of the inverter 310 so that the inverter current I2 as illustrated in FIG. 5 flows to the inverter 310. As compared with the example of FIG. 6, the pulsation component of the smoothing unit current I3 is reduced. Under the control of the control unit 400, the inverter current I2 contains an electric current of a component including a pulsation current whose main component is a frequency component of the converter current I1. In this way, the pulsation current to be flown into the smoothing unit 200 from the converter 700 is reduced, so that the pulsation of the smoothing unit current I3 is reduced.

The frequency component of the converter current I1 is determined according to the frequency of the alternating-current voltage supplied from the commercial power supply 110, the configuration of the rectification unit 130, and the switching speed of the switching element 632 of the boosting unit 600. Therefore, the control unit 400 can set the frequency component of the pulsation current to be superimposed on the inverter current I2 as a component having predetermined amplitude and phase. The frequency component of the pulsation current superimposed on the inverter current I2 has a similar waveform of the frequency component of the converter current I1. The control unit 400 can reduce the pulsation component of the smoothing unit current I3 as the frequency component of the pulsation current superimposed on the inverter current I2 approaches the frequency component of the converter current I1. In addition, at this time, the pulsation voltage generated in the capacitor voltage Vdc can also be reduced.

The control unit 400 controlling the pulsation of an electric current flowing in the inverter 310 by controlling the operation of the inverter 310 is equivalent to controlling the pulsation of the alternating-current power supplied from the inverter 310 to the compressor 315. The control unit 400 controls the operation of the inverter 310 so that the pulsation included in the alternating-current power outputted from the inverter 310 is smaller than the pulsation of the power outputted from the converter 700.

Note that the control unit 400 only has to determine the frequency component of the pulsation current to be superimposed on the inverter current I2, in accordance with the alternating-current power supplied from the commercial power supply 110. Specifically, in the case where the alternating-current power supplied from the commercial power supply 110 is single-phase power, the control unit 400 controls the pulsation waveform of the inverter current I2 to form a shape obtained by adding a direct-current component to a pulsation waveform the main component of which is a frequency component twice the frequency of the alternating-current power. In addition, in the case where the alternating-current power supplied from the commercial power supply 110 is three-phase power, the control unit 400 controls the pulsation waveform of the inverter current I2 to form a shape obtained by adding a direct-current component to a pulsation waveform the main component of which is a frequency component six times the frequency of the alternating-current power. The pulsation waveform has, for example, a shape of an absolute value of a sine wave or a shape of a sine wave. In this case, the control unit 400 may add at least one frequency component among components of integral multiples of the frequency of the sine wave as a predefined amplitude to the pulsation waveform. In addition, the pulsation waveform may have a rectangular wave shape or a triangular wave shape. In this case, the control unit 400 may set the amplitude and the phase of the pulsation waveform to a predefined value.

The control unit 400 can calculate a pulsation amount of pulsation included in the inverter current I2 using the smoothing unit current I3 obtained by calculation. Note that, alternatively, the control unit 400 may calculate the pulsation amount of pulsation included in the inverter current I2 using the capacitor voltage Vdc or the electric voltage or current of the alternating-current power supplied from the commercial power supply 110.

In addition, when controlling the inverter 310 to output alternating-current power including the frequency component different from the frequency component of the alternating-current power supplied from the commercial power supply 110 from the inverter 310 to the compressor 315, the control unit 400 may superimpose the frequency component included in the alternating-current power outputted from the inverter 310 to the compressor 315 on a drive signal for turning on and off the switching element 632 of the boosting unit 600. Specifically, in the case where the alternating-current power supplied from the commercial power supply 110 is single-phase power, the operation of the converter 700 is controlled so that power including a fluctuation frequency component other than a frequency component that is twice the frequency of the alternating-current power is outputted from the converter 700. In addition, in the case where the alternating-current power supplied from the commercial power supply 110 is three-phase power, the operation of the converter 700 is controlled so that power including a fluctuation frequency component other than a frequency component that is six times the frequency of the alternating-current power is outputted from the converter 700.

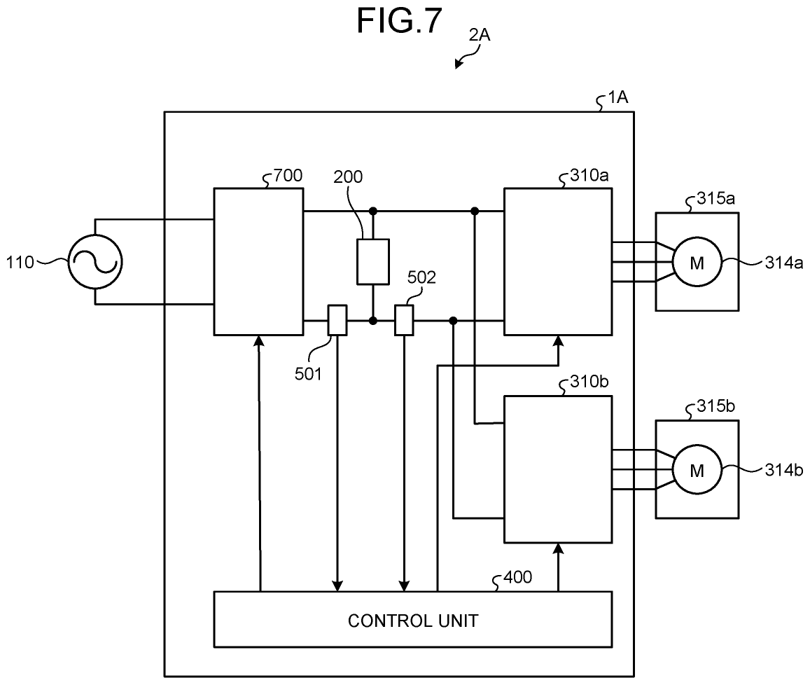

Next, a power converting apparatus that extends the lifetime of the capacitor 210 through the use of the above-described apparatus configuration in which two or more inverters are connected to one converter will be described. FIG. 7 is a diagram illustrating a configuration example of the power converting apparatus according to the first embodiment. The power converting apparatus 1A illustrated in FIG. 7 is configured to be capable of using the basic functions of the power converting apparatus 1 illustrated in FIG. 1. Note that components that are the same as or equivalent to the constituent elements of the power converting apparatus 1 illustrated in FIG. 1 are denoted by the same reference symbols, and their redundant description will be omitted as appropriate.

As illustrated in FIG. 7, the power converting apparatus 1A according to the first embodiment includes the converter 700, the smoothing unit 200, the current detection units 501 and 502, an inverter 310a that is a first inverter, an inverter 310b that is a second inverter, and the control unit 400. The converter 700 is connected to the commercial power supply 110. A motor 314a that is a first motor is installed in a device 315a that is a first device. An example of the device 315a is a compressor, and another example of the device 315a is a fan. The inverter 310a is connected to the motor 314a of the device 315a. A motor 314b that is a second motor is installed in a device 315b that is a second device. An example of the device 315b is a fan, and another example of the device 315b is a compressor. The inverter 310b is connected to the motor 314b of the device 315b. The power converting apparatus 1A, the motor 314a included in the device 315a, and the motor 314b included in the device 315b constitute a motor drive apparatus 2A. Note that, in FIG. 7, illustration of configuration parts equivalent to the current detection units 313a and 313b illustrated in FIG. 1 is omitted.

As illustrated in FIG. 7, the power converting apparatus 1A is configured such that the inverter 310a and the inverter 310b are connected to one converter 700 with the inverters being in parallel connection with each other. That is, the inverter 310a is connected to the converter 700 in parallel connection with the inverter 310b. In addition, the inverter 310b is connected to the converter 700 in parallel connection with the inverter 310a. With this configuration, the inverter 310a converts the power outputted from the converter 700 and the smoothing unit 200 into a first alternating-current power, and outputs the first alternating-current power to the device 315a in which the motor 314a is installed. Similarly, the inverter 310b converts the power outputted from the converter 700 and the smoothing unit 200 into a second alternating-current power, and outputs the second alternating-current power to the device 315b in which the motor 314b is installed. With this configuration, since the converter 700, the smoothing unit 200, and the control unit 400 can be used in common, the apparatus can be simplified while reducing an increase in cost of the apparatus.

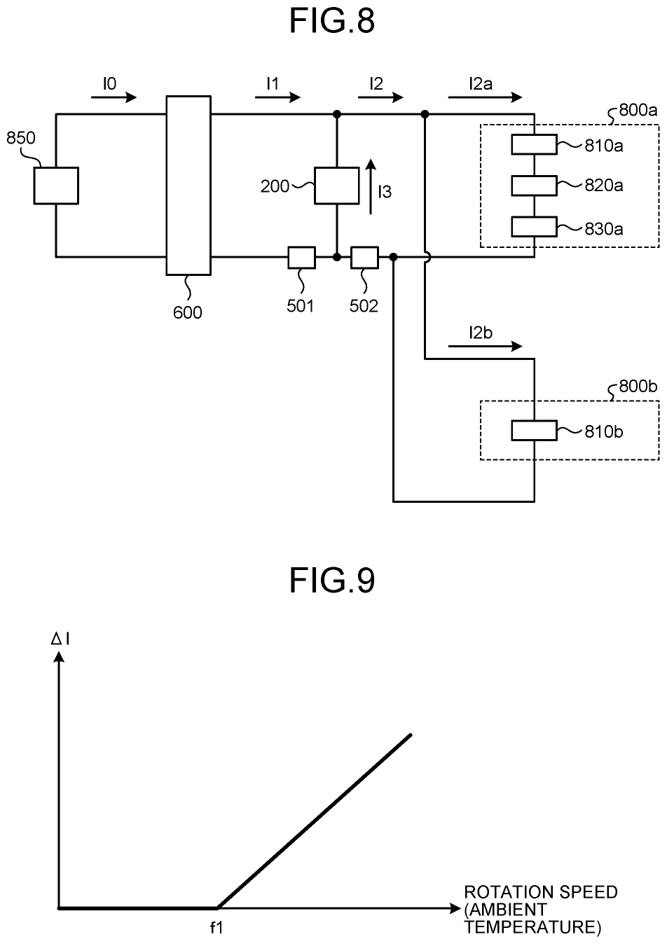

FIG. 8 is a diagram illustrating a first configuration example embodying the power converting apparatus according to the first embodiment. In FIG. 8, components that are the same as or equivalent to the constituent elements illustrated in FIG. 1 or 7 are denoted by the same reference symbols.

FIG. 8 illustrates, as circuit elements, a power supply unit 850, the boosting unit 600, the smoothing unit 200, the current detection units 501 and 502, a load unit 800a that is a first load unit, and a load unit 800b that is a second load unit.

The power supply unit 850 includes the commercial power supply 110 and the rectification unit 130 as constituent elements thereof. The load unit 800a includes, in addition to a constant current load unit 810a, a pulsation load compensation unit 820a and a power supply pulsation compensation unit 830a as constituent elements thereof. The load unit 800b includes only a constant current load unit 810b as a constituent element thereof.

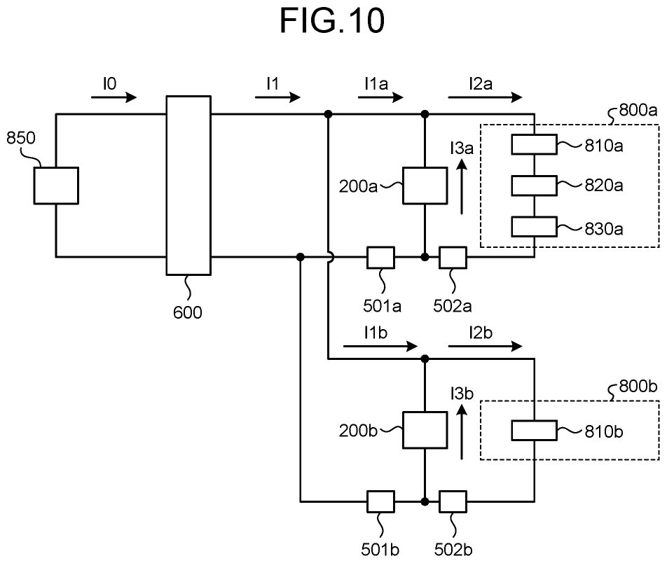

FIG. 8 is a configuration diagram based on the assumption that the power converting apparatus 1A is applied to an air conditioner. The same assumption applies to the drawings of FIGS. 10 to 13 described later. Specifically, in FIG. 8, the constant current load unit 810a is assumed to be a compressor motor load, and the constant current load unit 810b is assumed to be a fan motor load.

Here, in the description of FIGS. 5 and 6, it is assumed that a constant current load is connected to the smoothing unit 200. On the other hand, it is also known that some types of compressors have a mechanism that causes periodic rotational fluctuation. When such a compressor motor load is used, the above-described vibration reduction control is performed. In the constant torque control, a constant current is outputted from the inverter 310, but in the vibration reduction control, a pulsation current component corresponding to the vibration reduction torque flows to the load separately from the constant current. As illustrated in FIG. 8, an element through which the pulsation current component flows can be expressed by a form obtained by adding the pulsation load compensation unit 820a to the constant current load unit 810a.

Similarly, when the power supply pulsation compensation control described above is performed, a pulsation current component under the power supply pulsation compensation control flows in the load. As illustrated in FIG. 8, an element through which the pulsation current component flows can be expressed by a form obtained by further adding the power supply pulsation compensation unit 830a.

Note that the load unit 800b is not provided with a pulsation load compensation unit and a power supply pulsation compensation unit. This means that the vibration reduction control and the power supply pulsation compensation control are not performed in the load unit 800b.

Next, the operation of the power converting apparatus 1A that extends the lifetime of the capacitor 210 will be described with reference to FIG. 8. First, the signs added in FIG. 8 will be described, and “I0” is a rectified electric current before being boosted that flows between the power supply unit 850 and the boosting unit 600. In this part, it is simply referred to as a “rectified current”. Note that, when compared with the rectified current I0, the converter current I1 corresponds to the rectified current after boosting. In addition, “I2a” represents an electric current of the inverter current I2 that is shunted to the load unit 800a, and “I2b” represents an electric current of the inverter current I2 that is shunted to the load unit 800b. In this part, both of them are referred to as “shunt current”. Note that, in the following description, for the sake of simplicity, the content of the control for making the pulsation component of the smoothing unit current I3 zero will be described, but it is sufficient if the pulsation component of the smoothing unit current I3 is reduced as compared with that before the control, and it is not always necessary to make the pulsation component of the smoothing unit current I3 zero.

As described above, the power converting apparatus 1A according to the first embodiment has a function of the power supply pulsation compensation control. The following control is performed using this function.

In the configuration of FIG. 8, when a relationship I1=(I2a+I2b) is established between the converter current I1 and the shunt currents I2a and I2b of the inverter current I2, I3=0 is satisfied. On the other hand, for the reason of the power supply pulsation, in the phase of the power supply voltage in which a relationship I1>(I2a+I2b) is established, an electric current difference ΔI3={I1−(I2a+I2b)} flows into the capacitor 210. Similarly, when a relationship I1<(I2a+I2b) is established, an electric current difference ΔI3={(I2a+I2b)−I1} flows out of the smoothing unit 200. In this situation, control is performed such that the alternating-current component of the converter current I1 and the alternating-current component of the sum of the shunt currents, i.e., (I2a+I2b) are equal to each other. Specifically, a pulsation current is generated in the power supply pulsation compensation unit 830a, and the shunt current I2a is adjusted according to a change in the converter current I1. A change in the converter current I1 can be sensed on the basis of the detection value of the current detection unit 501. Thus, since the current difference ΔI3 can be brought close to zero, the current inflow amount and the current outflow amount with respect to the smoothing unit 200 can be reduced.

When the outflow amount and the inflow amount of the smoothing unit current I3 can be reduced, stress on the capacitor element can be reduced, and aging deterioration of the capacitor element can be reduced. Accordingly, the lifetime of the capacitor 210 can be extended. In addition, the capacitance of the capacitor element can be reduced by the reduced amount of the current inflow amount and the reduced amount of the current outflow amount obtained by this control, and the ripple capacity for the capacitor element is alleviated. As a result, since an inexpensive capacitor element can be used, an increase in cost of the apparatus can be restrained.

Next, effects obtained by the power converting apparatus 1A according to the first embodiment including the boosting unit 600 will be described. Note that, in the present description, the voltage before boosting, that is, the rectified voltage is referred to as “Vs”, and the boosted voltage that is the voltage after boosting is referred to as “Vb”.

In the boosting unit 600, the boost control is performed with respect to an input power determined by three elements: the rectified voltage Vs; the rectified current I0; and the power supply power factor, and the boosted voltage Vb and the converter current I1 are outputted. In general, since the voltage after the boosting satisfies Vs≤Vb, a characteristic of I1<I0 is obtained. Here, since the amount of current flowing in and out of the capacitor 210 is determined by the absolute value (=|I1−(I2a+I2b)|) of the current difference ΔI3, the amount of current is generally smaller when the boosting operation is performed at the time of power conversion. Therefore, when the boost control is actively performed, the current inflow amount and the current outflow amount with respect to the smoothing unit 200 can be reduced as compared with the case where the boost control is not performed.

Next, an operation performed using the configuration in which the power converting apparatus 1A according to the first embodiment includes the load unit 800a and the load unit 800b connected in parallel with the load unit 800a and effects thereof will be described. Note that, as described above, in the description with reference to FIG. 8, the load unit 800a is assumed to be a compressor motor load, and the load unit 800b is assumed to be a fan motor load.

The shunt current I2a includes a compensation current used in the pulsation load compensation unit 820a and a compensation current used in the power supply pulsation compensation unit 830a in addition to the current used in the constant current load unit 810a based on the assumption of constant torque load drive. Here, the inverter current I2=I2a+I2b can be detected by the current detection unit 502. In addition, the current value of the converter current I1 can be detected by the current detection unit 501.

Here, it is assumed that the load unit 800b including the fan motor load is currently performing the deceleration operation. In this case, a period in which the inverter output voltage in the load unit 800b decreases occurs due to the electromotive force generated in the load unit 800b. During this period, the load unit 800b is in a regeneration state, and power is not consumed in the load unit 800b. In this situation, since the shunt current I2b≤0, the current inflow to the smoothing unit 200 occurs. Thence, the pulsation current is generated in the power supply pulsation compensation unit 830a, and the shunt current I2a is adjusted according to a change in the shunt current I2b. By so doing, since the current difference ΔI3 can be brought close to zero, the current inflow amount and the current outflow amount with respect to the smoothing unit 200 can be reduced.

Note that, in the configuration of FIG. 8, the current detection unit 502 is a means of detecting the inverter current I2, but cannot directly detect the shunt current I2b. Since a change component of the inverter current I2 also includes a change component of the shunt current I2a, there may be a situation where a change in the shunt current I2b cannot be accurately detected. Thence, a method of correcting the pulsation current generated in the power supply pulsation compensation unit 830a will be proposed.

FIG. 9 is a chart used to describe a pulsation current correction method in the first embodiment. In FIG. 9, the horizontal axis represents the rotation speed, and the vertical axis represents the correction value of the pulsation current generated in the power supply pulsation compensation unit 830a. The correction of the pulsation current becomes necessary when the rotation speed is high. Therefore, as illustrated in FIG. 9, correction is not performed when the rotation speed is equal to or lower than a first rotation speed f1, and the pulsation current is corrected when the rotation speed exceeds the first rotation speed f1. In the method of FIG. 9, it is not necessary to directly sense a change in the shunt current I2b. Therefore, any detection unit for detecting the shunt current I2b is unnecessary. Accordingly, by using the method of FIG. 9, it is possible to simplify the apparatus while reducing an increase in cost of the apparatus.

Note that, in FIG. 9, a change in correction value ΔI of the pulsation current to be changed according to the rotation speed is represented by a straight line, but the present disclosure is not limited to this example. That is, a relationship between the rotation speed and the correction value ΔI of the pulsation current does not need to be a linear relationship, and may be represented by a high-dimensional function, e.g., a quadratic or higher-dimensional function.

In addition, in FIG. 9, the method of correcting the pulsation current on the basis of the rotation speed has been described, but the pulsation current may be corrected on the basis of the ambient temperature of the smoothing unit 200 or the ambient temperature of the inverters 310a and 310b. In this case, the correction may be performed in all the temperature ranges, or the correction may be performed only in a high temperature range by a method similar to that in FIG. 9. In addition, both the correction based on the rotation speed and the correction based on the ambient temperature may be performed.

Incidentally, in the case where the load unit 800a having the compressor motor load is a load having torque pulsation caused by a mechanical mechanism, acceleration and deceleration are performed during one revolution of the compressor, and thereby a regeneration state may be instantaneously caused. At this time, since the shunt current satisfies I2a≤0, the current inflow to the smoothing unit 200 occurs. In the circumstances, when the load unit 800a is in the regeneration state, the pulsation current is generated in the power supply pulsation compensation unit 830a and caused to flow into the shunt current I2a. In this way, even when the load unit 800a is in the regeneration state, an increase in the current difference ΔI3 can be restrained.

As described above, according to the power converting apparatus 1A of the first embodiment, since the converter 700 includes the boosting unit 600, it is possible to reduce the outflow amount and the inflow amount of the smoothing unit current I3 through the use of the boosting operation of the boosting unit 600. In addition, according to the power converting apparatus 1A of the first embodiment, since the load units connected to the output ends of the converter 700 with the units being in parallel connection with each other are provided, it is possible to reduce the outflow amount and the inflow amount of the smoothing unit current I3 by effectively using the regeneration state of the load unit in question. By this means, stress on the capacitor element can be reduced, and aging deterioration of the capacitor element can be reduced, so that the lifetime of the capacitor 210 can be extended. In addition, since the capacitance of the capacitor element can be reduced and the ripple capacity with respect to the capacitor element can be alleviated, an inexpensive capacitor element can be used. Thus, it is possible to reduce an increase in cost of the apparatus.

Note that although FIG. 8 illustrates the configuration in which one load unit 800a and one load unit 800b are connected to the output ends of the converter 700 with the units 800a and 800b being in parallel connection with each other, the present disclosure is not limited to this example. The load unit 800a that is the first load unit may be a first load group including two or more load units connected in parallel with each other. Similarly, the load unit 800b that is the second load unit may be a second load group including two or more load units connected in parallel with each other. The above-described effects can be obtained by operation of at least one load unit of the first load group.

In addition, in the above, the load unit 800a is described as the first load unit and the load unit 800b is described as the second load unit, but wording of the first and second load units is used for convenience, and the load unit 800a may be referred to as a second load unit, and the load unit 800b may be referred to as a first load unit.

In addition, the power converting apparatus 1A according to the first embodiment illustrated in FIG. 7 may be configured as illustrated in FIG. 10 instead of the configuration illustrated in FIG. 8. FIG. 10 is a diagram illustrating a second configuration example embodying the power converting apparatus according to the first embodiment. In FIG. 10, components that are the same as or equivalent to the components illustrated in FIG. 8 are denoted by the same reference symbols.

In FIG. 8, the inverter 310a and the inverter 310b are connected to one smoothing unit 200 with the inverters being in parallel connection with each other. Instead of this configuration, in FIG. 10, a smoothing unit 200a that is a first smoothing unit is connected to the input ends of the inverter 310a, and a smoothing unit 200b that is a second smoothing unit is connected to the input ends of the inverter 310b. That is, a configuration in FIG. 10 is such that the smoothing unit 200a and the smoothing unit 200b are connected to one converter 700 with the units 200a and 200b being in parallel connection with each other. In addition, since the smoothing units 200a and 200b are provided instead of the smoothing unit 200, a current detection unit 501a for detecting a shunt current I1a and a current detection unit 502a for detecting an inverter current I2a are provided on the load unit 800a side. In a similar fashion, on the load unit 800b side, a current detection unit 501b for detecting a shunt current I1b and a current detection unit 502b for detecting an inverter current I2b are provided. Note that the shunt current I1a represents an electric current of the converter current I1 that is shunted to the load unit 800a. In addition, the shunt current I1b represents an electric current of the converter current I1 that is shunted to the load unit 800b.

In the configuration of FIG. 10, the magnitude of a smoothing unit current I3a flowing into and out of the smoothing unit 200a can be expressed as I1a−I2al. Similarly, the magnitude of a smoothing unit current I3b flowing into and out of the smoothing unit 200b can be expressed as |I1b−I2b|. With this configuration, the number of components increases, but it is possible to avoid a situation where a load is concentrated onto one smoothing unit. Accordingly, as compared with the configuration of FIG. 8, stress on one capacitor element can be dispersed to two capacitor elements, so that the deterioration of the capacitor elements can be restrained.

In addition, in the configuration of FIG. 10, the current detection unit 501a capable of directly detecting the shunt current I1a and the current detection unit 502a capable of directly detecting the inverter current I2a are provided, while the current detection unit 501b capable of directly detecting the shunt current I1b and the current detection unit 502b capable of directly detecting the inverter current I2b are provided. With this configuration, since the smoothing unit currents I3a and I3b can be calculated with high accuracy, avoidance of deterioration of the capacitor element can be realized with high accuracy.

In addition, in the configuration of FIG. 10, the current detection units 502a and 502b can directly detect the inverter currents I2a and I2b, respectively. By this means, since it is possible to instantaneously determine the regeneration state, it is possible to accurately determine whether or not the operation state of the load unit 800a is the regeneration state.

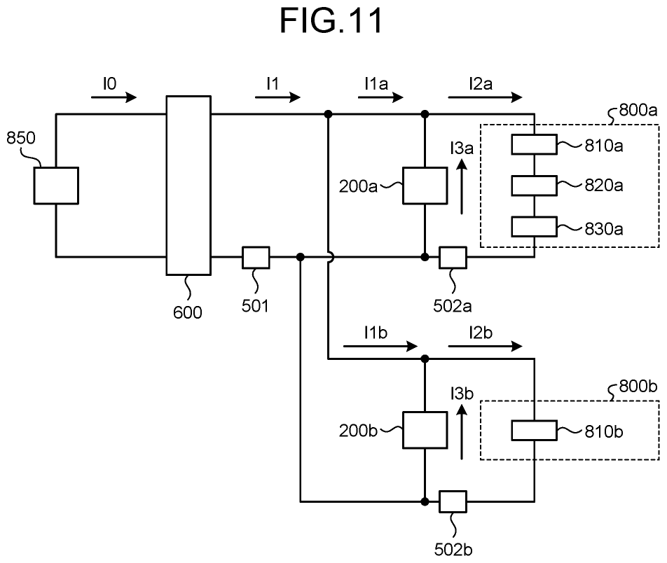

In addition, the power converting apparatus 1A according to the first embodiment illustrated in FIG. 7 may be configured as illustrated in FIG. 11 instead of the configuration illustrated in FIG. 10. FIG. 11 is a diagram illustrating a third configuration example embodying the power converting apparatus according to the first embodiment. In FIG. 11, components that are the same as or equivalent to the components illustrated in FIG. 10 are denoted by the same reference symbols.

In FIG. 11, the current detection units 501a and 501b illustrated in FIG. 10 are integrated, and the current detection unit 501 is provided on the side of the boosting unit 600 with respect to the connection point between the boosting unit 600 and the smoothing unit 200b. This configuration is effective in the case where a current ratio between the current flowing in and out of the load unit 800a and the current flowing in and out of the load unit 800b can be grasped in advance. In the case where the current ratio can be grasped in advance, the shunt currents I1a and I1b can be obtained by calculation on the basis of the detection value of the current detection unit 501 that detects the converter current I1. As a result, it is possible to simplify the current detection unit while obtaining the effects of the second configuration example illustrated in FIG. 10.

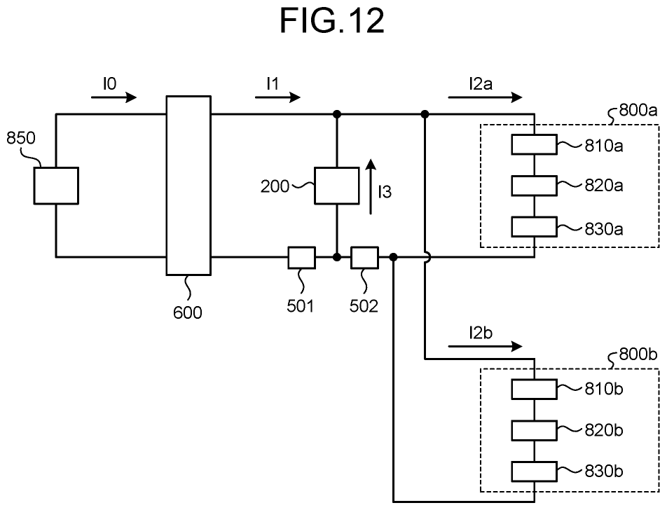

In addition, the power converting apparatus 1A according to the first embodiment illustrated in FIG. 7 may be configured as illustrated in FIG. 12 instead of the configuration illustrated in FIG. 8. FIG. 12 is a diagram illustrating a fourth configuration example embodying the power converting apparatus according to the first embodiment. In FIG. 12, components that are the same as or equivalent to the components illustrated in FIG. 8 are denoted by the same reference symbols.

In FIG. 12, each of the constant current load units 810a and 810b is assumed to be a compressor motor load. Similarly to FIG. 8, FIG. 12 illustrates, as circuit elements, the power supply unit 850, the boosting unit 600, the smoothing unit 200, the current detection units 501 and 502, and the load units 800a and 800b. The load unit 800a includes the constant current load unit 810a, the pulsation load compensation unit 820a, and the power supply pulsation compensation unit 830a as constituent elements thereof. Similarly, the load unit 800b includes the constant current load unit 810b, a pulsation load compensation unit 820b, and a power supply pulsation compensation unit 830b as constituent elements thereof. A difference from FIG. 8 is a feature that the load unit 800b includes the pulsation load compensation unit 820b and the power supply pulsation compensation unit 830b as constituent elements thereof.

Here, it is assumed that both the load units 800a and 800b each having a compressor motor load are currently performing deceleration operation. In this situation, a period in which the inverter output voltage in the load unit 800a decreases occurs due to an electromotive force generated in the load unit 800a. Similarly, a period in which the inverter output voltage in the load unit 800b decreases occurs due to an electromotive force generated in the load unit 800b. Therefore, both the load units 800a and 800b can be in the regeneration state. Then, in the period in which both are in the regeneration state, the shunt current satisfies I2a≤0 and the shunt current satisfies I2b≤0, so that current inflow to the smoothing unit 200 occurs.

Thence, in a period in which both the load units 800a and 800b are in the regeneration state, the pulsation current is generated in the power supply pulsation compensation unit 830a, and the shunt current I2a is adjusted according to a change in the shunt current I2b. At the same time, the pulsation current is generated in the power supply pulsation compensation unit 830b, and the shunt current I2b is adjusted according to a change in the shunt current I2a. In this way, since the current difference ΔI3 can be brought close to zero while restraining an increase in current difference ΔI3, the current inflow amount and the current outflow amount with respect to the smoothing unit 200 can be reduced.

In addition, in the case where the load unit 800a having the compressor motor load is a load having some torque pulsation caused by a mechanical mechanism, acceleration and deceleration are performed during one revolution of the compressor, and thereby the regeneration state may be instantaneously experienced. In this situation, since the shunt current satisfies I2a≤0, the current inflow to the smoothing unit 200 occurs. Thence, when the load unit 800a is in the regeneration state, the pulsation current is generated in the power supply pulsation compensation unit 830a and caused to flow into the shunt current I2a. In this way, even when the load unit 800a is in the regeneration state, an increase in the current difference ΔI3 can be restrained.

In addition, in the case where the load unit 800b having the compressor motor load is a load having some torque pulsation caused by a mechanical mechanism, acceleration and deceleration are performed during one revolution of the compressor, and thereby the regeneration state may be instantaneously experienced. In this situation, since the shunt current satisfies I2b≤0, the current inflow to the smoothing unit 200 occurs. Thence, when the load unit 800b is in the regeneration state, the pulsation current is generated in the power supply pulsation compensation unit 830b and caused to flow into the shunt current I2b. In this way, even when the load unit 800b is in the regeneration state, an increase in the current difference ΔI3 can be restrained.

As described above, even when each of the load units 800a and 800b is a compressor motor load, the outflow amount and the inflow amount of the smoothing unit current I3 can be reduced through effective use of the regeneration state of both the load units 800a and 800b. By this means, stress on the capacitor element can be reduced, and aging deterioration of the capacitor element can be reduced, so that the lifetime of the capacitor 210 can be extended. In addition, since the capacitance of the capacitor element can be reduced and the ripple capacity for the capacitor element is alleviated, an inexpensive capacitor element can be used. As a result, it is possible to reduce an increase in cost of the apparatus.

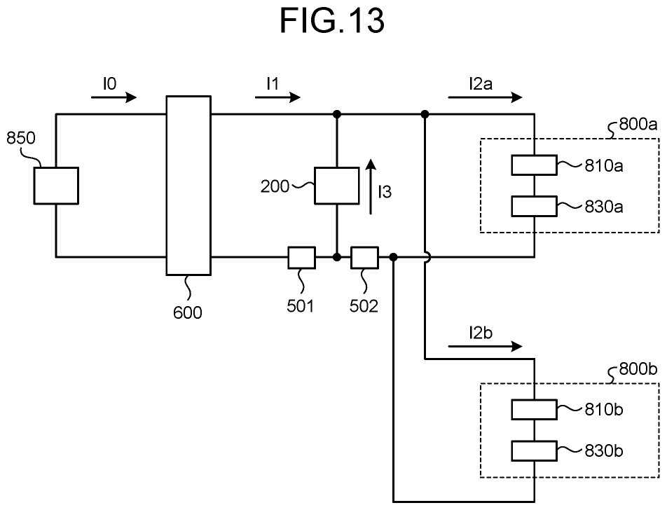

In addition, the power converting apparatus 1A according to the first embodiment illustrated in FIG. 7 may be configured as illustrated in FIG. 13 instead of the configuration illustrated in FIG. 12. FIG. 13 is a diagram illustrating a fifth configuration example embodying the power converting apparatus according to the first embodiment. In FIG. 13, components that are the same as or equivalent to the components illustrated in FIG. 12 are denoted by the same reference symbols.

In FIG. 13, both the constant current load units 810a and 810b are assumed to be fan motor loads. Since each of the constant current load units 810a and 810b is a fan motor load, the load unit 800a includes the constant current load unit 810a and the power supply pulsation compensation unit 830a as constituent elements thereof. Similarly, the load unit 800b includes the constant current load unit 810b and the power supply pulsation compensation unit 830b as constituent elements thereof. That is, a difference from FIG. 12 in FIG. 13 is a feature that the pulsation load compensation units 820a and 820b are not provided in the load units 800a and 800b.

Here, it is assumed that both the load units 800a and 800b having the fan motor load is currently performing a deceleration operation. In this situation, a period in which the inverter output voltage in the load unit 800a decreases occurs due to the electromotive force generated in the load unit 800a. Similarly, a period in which the inverter output voltage in the load unit 800b decreases occurs due to the electromotive force generated in the load unit 800b. Therefore, both the load units 800a and 800b can be in the regeneration state. Then, in the period in which both are in the regeneration state, the shunt current satisfies I2a≤0 and the shunt current satisfies I2b≤0, so that current inflow to the smoothing unit 200 occurs.

Thence, in a period in which both the load units 800a and 800b are in the regeneration state, the pulsation current is generated in the power supply pulsation compensation unit 830a, and the shunt current I2a is adjusted according to a change in the shunt current I2b. At the same time, the pulsation current is generated in the power supply pulsation compensation unit 830b, and the shunt current I2b is adjusted according to a change in the shunt current I2a. In this way, since the current difference ΔI3 can be brought close to zero while restraining an increase in current difference ΔI3, the current inflow amount and the current outflow amount with respect to the smoothing unit 200 can be reduced.

As described above, even when each of the load units 800a and 800b is a fan motor load, the outflow amount and the inflow amount of the smoothing unit current I3 can be reduced through effectively use of the regeneration states of both the load units 800a and 800b. By this means, stress on the capacitor element can be reduced, and aging deterioration of the capacitor element can be reduced, so that the lifetime of the capacitor 210 can be extended. In addition, since the capacitance of the capacitor element can be reduced and the ripple capacity for the capacitor element is alleviated, an inexpensive capacitor element can be used. As a result, it is possible to reduce an increase in cost of the apparatus.

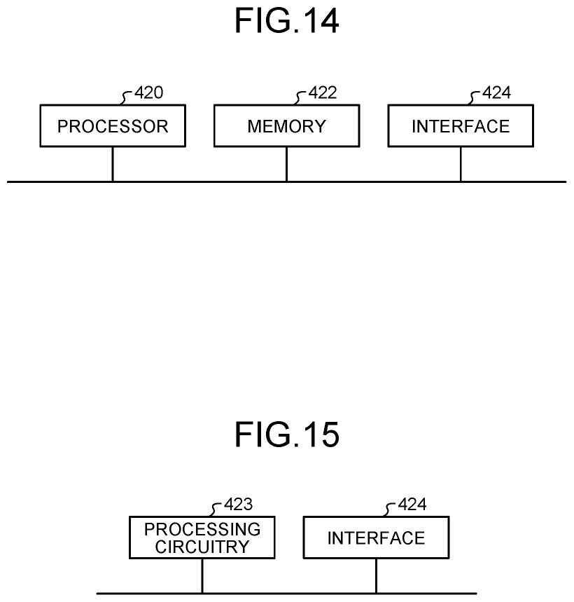

Next, a hardware configuration for achieving the function of the control unit 400 according to the first embodiment will be described with reference to the drawings of FIGS. 14 and 15. FIG. 14 is a block diagram illustrating an example of a hardware configuration by which a function of the control unit according to the first embodiment is implemented. FIG. 15 is a block diagram illustrating another example of a hardware configuration by which the function of the control unit according to the first embodiment is implemented.

In a case where a part or all of the functions of the control unit 400 in the first embodiment are achieved, as illustrated in FIG. 14, a configuration can be adopted in which a processor 420 that performs calculation, a memory 422 in which a program to be read by the processor 420 is stored, and an interface 424 that inputs and outputs signals are included.

The processor 420 may be a calculation means such as a calculation device, a microprocessor, a microcomputer, a central processing unit (CPU), or a digital signal processor (DSP). In addition, examples of the memory 422 include: a nonvolatile or volatile semiconductor memory such as a random access memory (RAM), a read only memory (ROM), a flash memory, an erasable programmable ROM (EPROM), or an electrically EPROM (EEPROM (registered trademark)); a magnetic disk; a flexible disk; an optical disk; a compact disc; a mini disc; and a digital versatile disc (DVD).

In the memory 422, a program for executing the function of the control unit 400 in the first embodiment is stored. The processor 420 can perform the above-described processing by the processor 420 receiving and transmitting necessary information via the interface 424, the processor 420 executing the program stored in the memory 422, and the processor 420 referring to a table stored in the memory 422. The calculation result obtained by the processor 420 can be stored in the memory 422.

In addition, in a case where part of the functions of the control unit 400 in the first embodiment is achieved, a processing circuitry 423 illustrated in FIG. 15 can also be used. The processing circuitry 423 corresponds to a single circuit, a composite circuit, an application specific integrated circuit (ASIC), a field-programmable gate array (FPGA), or a combination thereof. Information inputted to the processing circuitry 423 and information outputted from the processing circuitry 423 can be acquired via the interface 424.

Note that partial processing in the control unit 400 may be performed by the processing circuitry 423, and processing not performed by the processing circuitry 423 may be performed by the processor 420 and the memory 422.

As described above, the power converting apparatus according to the first embodiment includes the converter, the smoothing unit and the first inverter connected to the output ends of the converter, the second inverter connected in parallel with the first inverter, and the control unit. The control unit controls the operation of the first inverter or the second inverter to reduce an electric current flowing in the smoothing unit, and concurrently controls the operation of the first inverter in accordance with the operation state of the second inverter and the second load unit including the second device in which the second motor is installed. That is, the power converting apparatus according to the first embodiment uses an apparatus configuration in which a plurality of devices is driven by one converter and a plurality of inverters connected to the converter, to perform control to reduce an electric current flowing in the smoothing unit. In this way, since the outflow amount and the inflow amount of an electric current flowing in the smoothing unit can be reduced, stress on the capacitor element can be reduced, and aging deterioration of the capacitor element can be restrained. As a result, the lifetime of the smoothing unit can be extended.

### Second Embodiment

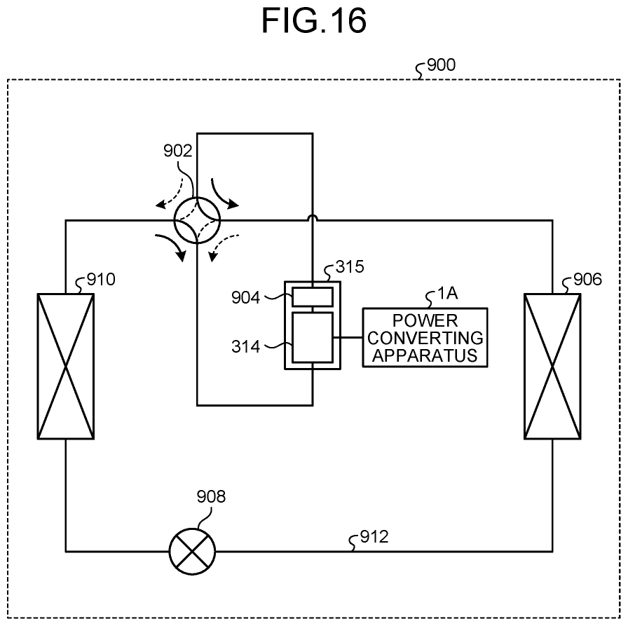

FIG. 16 is a diagram illustrating a configuration example of a refrigeration cycle application device 900 according to the second embodiment. The refrigeration cycle application device 900 according to the second embodiment includes the power converting apparatus 1A described in the first embodiment. The refrigeration cycle application device 900 according to the second embodiment can be applied to a product having a refrigeration cycle, such as an air conditioner, a refrigerator, a freezer, or a heat pump water heater. Note that, in FIG. 16, constituent elements having functions similar to those in the first embodiment are denoted by the same reference symbols as those in the first embodiment.

The refrigeration cycle application device 900 includes the compressor 315 in which the motor 314 of the first embodiment has been incorporated, a four-way valve 902, an indoor heat exchanger 906, an expansion valve 908, and an outdoor heat exchanger 910, which are attached via a refrigerant pipe 912.

A compression mechanism 904 that compresses a refrigerant and the motor 314 that operates the compression mechanism 904 are provided inside the compressor 315.

The refrigeration cycle application device 900 can perform a heating operation or a cooling operation in response to a switching operation for the four-way valve 902. The compression mechanism 904 is driven by the motor 314 that is variable-speed controlled.

During the heating operation, as indicated by solid arrows, the refrigerant is pressurized and sent out by the compression mechanism 904, and returns to the compression mechanism 904 through the four-way valve 902, the indoor heat exchanger 906, the expansion valve 908, the outdoor heat exchanger 910, and the four-way valve 902.

During the cooling operation, as indicated by broken arrows, the refrigerant is pressurized and sent out by the compression mechanism 904, and returns to the compression mechanism 904 through the four-way valve 902, the outdoor heat exchanger 910, the expansion valve 908, the indoor heat exchanger 906, and the four-way valve 902.

During the heating operation, the indoor heat exchanger 906 acts as a condenser to release heat, and the outdoor heat exchanger 910 acts as an evaporator to absorb heat. During the cooling operation, the outdoor heat exchanger 910 acts as a condenser to release heat, and the indoor heat exchanger 906 acts as an evaporator to absorb heat. The expansion valve 908 depressurizes and expands the refrigerant.

The configurations described in the above embodiments illustrate just examples, and can each be combined with other publicly known techniques. Besides, the embodiments can be combined with each other, and a part of the configuration can be omitted and/or modified without departing from the scope of the present disclosure.

1. A power converting apparatus comprising:
a converter rectifying a power supply voltage applied from an alternating-current power supply and, if necessary, boosting the power supply voltage;
a smoothing unit connected to an output end of the converter;
a first inverter connected to the output end of the converter, the first inverter converting power outputted from the converter and the smoothing unit into a first alternating-current power and outputting the first alternating-current power to a first device in which a first motor is installed;
a second inverter connected in parallel with the first inverter, the second inverter converting power outputted from the converter and the smoothing unit into a second alternating-current power and outputting the second alternating-current power to a second device in which a second motor is installed; and
a control unit controlling an operation of the converter, the first inverter, or the second inverter to reduce an electric current flowing in the smoothing unit, and concurrently controlling an operation of the first inverter in accordance with an operation state of the second inverter and a second load unit, the second load unit including the second device.

2. The power converting apparatus according to claim 1, wherein
the control unit controls the operation of the first inverter in accordance with the operation state of the second load unit and concurrently controls an operation of the second inverter in accordance with an operation state of the first inverter and a first load unit including the first device in which the first motor is installed.

3. The power converting apparatus according to claim 2, wherein
the control unit generates a pulsation current in the first inverter during a period in which the operation state of the second load unit is in a regeneration state, and generates a pulsation current in the second inverter during a period in which the operation state of the first load unit is in the regeneration state.

4. The power converting apparatus according to claim 3, wherein
the control unit corrects the pulsation current based on a rotation speed of the second motor.

5. The power converting apparatus according to claim 3, wherein
the control unit corrects the pulsation current based on an ambient temperature of the power converting apparatus.

6. The power converting apparatus according to claim 2, wherein
the operation states of the first and second load units are obtained based on at least one of: a detection value of a detection unit detecting a physical quantity with using the first and second inverters, the first and second motors, or the first and second devices, as an object to be detected; a command value generated in the course of control of the control unit; and an estimation value estimated in the course of control of the control unit.

7. The power converting apparatus according to claim 1, wherein
the smoothing unit consists of first and second smoothing units,
the first smoothing unit is connected to an input end of the first inverter, and
the second smoothing unit is connected to an input end of the second inverter.

8. The power converting apparatus according to claim 7, comprising a first detection unit detecting an electric current flowing in the first inverter and a second detection unit detecting an electric current flowing in the second inverter, wherein
the control unit determines whether or not the first inverter is in a regeneration state, based on a detection value obtained by the first detection unit, and determines whether or not the second inverter is in a regeneration state based on a detection value obtained by the second detection unit.

9. A motor drive apparatus comprising the power converting apparatus according to claim 1.

10. The motor drive apparatus according to claim 9, wherein
the first device is a compressor, and
the second device is a fan.

11. The motor drive apparatus according to claim 9, wherein
the first and second devices are compressors.

12. The motor drive apparatus according to claim 9, wherein
the first and second devices are fans.

13. A refrigeration cycle application device comprising the power converting apparatus according to claim 1.

14. A refrigeration cycle application device comprising the motor drive apparatus according to claim 9.
